(19) United States
(12) Patent Application Publication
(10) Pub. No.: US 2012/0099543 A1
(43) Pub. Date: Apr. 26, 2012

(54) TRANSMISSION METHOD OF BASE STATION FOR RANDOM ACCESS RESOURCE ALLOCATION, TRANSMISSION METHOD OF TERMINAL FOR USING THE RANDOM ACCESS RESOURCE ALLOCATION, AND APPARATUS FOR THEREOF

(75) Inventors: Mi Jeong YANG, Daejeon (KR); Soon Yong LIM, Daejeon (KR); Aesoon PARK, Daejeon (KR)

(73) Assignee: Electronics and Telecommunications Research Institute, Daejeon (KR)

(21) Appl. No.: 13/277,805

(22) Filed: Oct. 20, 2011

(30) Foreign Application Priority Data
Oct. 22, 2010 (KR) 10-2010-0103354

(51) Int. Cl. H04W 74/08

(52) U.S. Cl. 370/329

(57) ABSTRACT

Provided is a communication method of a base station for random access resource allocation, the communication method including broadcasting system information (SI) that includes information about an extra physical random access channel (xPRACH) of a machine type communication (MTC) terminal and information about a physical random access channel (PRACH) of a general terminal, each of the xPRACH of the MTC terminal and the PRACH of the general terminal having a separated resource space, and receiving a random access attempt from the MTC terminal in response to the broadcast.

### FIELD OF THE INVENTION

The present invention relates to a communication method of a base station for a random access resource allocation, a communication method of a terminal using a random access resource allocation, and devices thereof.

### DESCRIPTION OF THE RELATED ART

Nowadays, the 3rd generation partnership project (3GPP) is performing standardization of machine type communication (MTC) for intelligent communication between a person and a machine, and among machines. Representative services using the MTC may include a time controlled MTC terminal.

Time controlled MTC terminals may wake up simultaneously at a predetermined point in time, and may provide predetermined information to a server or other devices. In this example, connection requests may occur simultaneously from multiple terminals, which may cause a random access channel (RACH) intensity.

An MTC terminal may have a delay-tolerant characteristic of waiting for a subsequent scheduled transmission opportunity, when the corresponding information is not transmitted in an original scheduled timeslot, to transmit information. An example of a service having the delay-tolerant characteristic may include a smart metering that informs the world of a need for standardization of machine to machine communication.

Accordingly, there is a desire for a communication method that may efficiently control an RACH overload while minimizing an effect on a general terminal, for example, a general communication terminal, and the like due to the RACH intensity resulting from the time controlled MTC terminal having the delay-tolerant characteristic.

### DESCRIPTION OF THE INVENTION

### Subjects to be Solved

An aspect of the present invention provides a communication method of a base station for a random access resource allocation, a communication method of a terminal using a random access resource allocation, and devices thereof that may variably allocate an extra physical physical random access channel (xPRACH) for a machine type communication (MTC) terminal in a mobile communication system based on a 3rd generation partnership project (3GPP) long term evolution (LTE) frame.

### Means for Solving the Subjects

According to an aspect of the present invention, there is provided a communication method of a base station for random access resource allocation, the communication method including broadcasting system information (SI) that includes information about an extra physical random access channel (xPRACH) of an MTC terminal and information about a PRACH of a general terminal, each of the xPRACH of the MTC terminal and the PRACH of the general terminal having a separated resource space, and receiving a random access attempt from the MTC terminal in response to the broadcast.

According to another aspect of the present invention, there is provided a communication method of a terminal using a random access resource allocation, the communication method including receiving, from a base station, SI that includes information about an xPRACH of an MTC terminal and information about a PRACH of a general terminal, each of the xPRACH of the MTC terminal and the PRACH of the general terminal having a separated resource space, setting the xPRACH of the MTC terminal based on the SI, and attempting a random access to the base station using the xPRACH of the MTC terminal.

According to still another aspect of the present invention, there is provided a base station for a random access resource allocation, the base station including a broadcasting unit to broadcast SI that includes information about an xPRACH of an MTC terminal and information about a PRACH of a general terminal, each of the xPRACH of the MTC terminal and the PRACH of the general terminal having a separated resource space, and a receiver to receive a random access attempt from the MTC terminal in response to the broadcast.

According to yet another aspect of the present invention, there is provided a terminal using a random access resource allocation, the terminal including a receiver to receive, from a base station, SI that includes information about an xPRACH of an MTC terminal and information about a PRACH of a general terminal, each of the xPRACH of the MTC terminal and the PRACH of the general terminal having a separated resource space, a setting unit to set the xPRACH of the MTC terminal based on the SI, and an attempt unit to attempt a random access to the base station using the xPRACH of the MTC terminal.

### Effect of the Invention

According to embodiments of the present invention, it is possible to control a physical allocation for an MTC terminal in a predetermined period and predetermined intensity without constraints using a period of duration for a PRACH of the MTC terminal and an index that designates a subframe used by the PRACH of the MTC terminal in a 3 GPP LTE based system.

According to embodiments of the present invention, it is possible to process a random access for an MTC terminal without influencing a random access for a general terminal by allocating a PRACH of the MTC terminal and a PRACH of the general terminal respectively to separated resource spaces.

According to embodiments of the present invention, it is possible to simplify a random access operation or a traffic transferring operation of an MTC terminal by allocating a PRACH of the MTC terminal and a PRACH of the general terminal to separate resource spaces, respectively, thereby distinguishing a random access for the MTC terminal from a random access, for the general terminal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an allocation and use of a physical channel resource in a network including a machine type communication (MTC) terminal and a general terminal according to embodiments of the present invention;

FIG. 2 is a flowchart illustrating a communication method of a base station for a random access resource allocation according to embodiments of the present invention;

FIG. 3 is a flowchart illustrating a communication method of a terminal using a random access resource allocation according to embodiments of the present invention;

FIG. 4 is a diagram illustrating an allocation of a physical channel resource for a general terminal according to embodiments of the present invention;

FIG. 5 is a diagram illustrating a configuration of a physical channel resource of FIG. 4;

FIG. 6 is a diagram illustrating an allocation of a physical channel resource for an MTC terminal according to embodiments of the present invention;

FIG. 7 is a diagram illustrating a subframe designated by an index that designates a subframe used by a physical random access channel (PRACH) of an MTC terminal according to embodiments of the present invention;

FIG. 8 is a block diagram illustrating a base station for a random access resource allocation according to embodiments of the present invention; and

FIG. 9 is a block diagram illustrating a terminal using a random access resource allocation according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

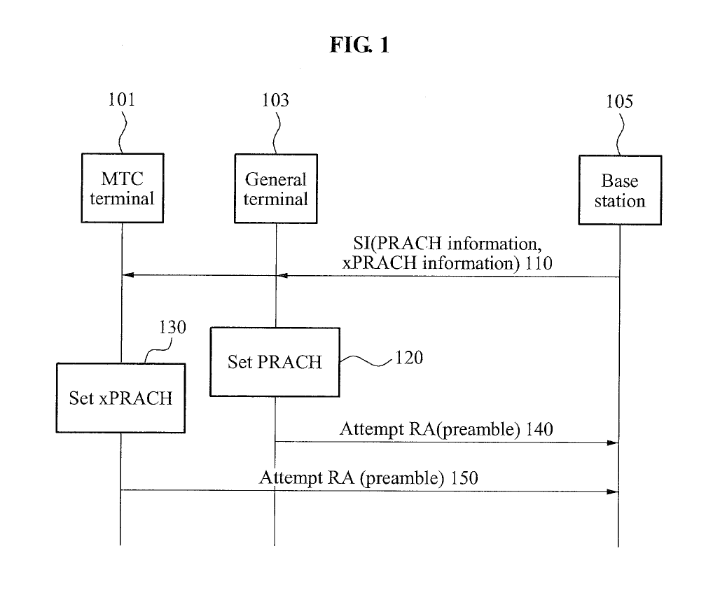

FIG. 1 is a diagram illustrating an allocation and use of a physical channel resource in a network including a machine type communication (MTC) terminal and a general terminal according to embodiments of the present invention.

Referring to FIG. 1, a network having an MTC terminal and a general terminal may include an MTC terminal 101, a general terminal 103, and a base station 105. Hereinafter, the general terminal 103 may refer to a general communication terminal other than an MTC terminal.

In operation 110, the base station 105 may broadcast system information (SI) that includes information about an extra physical random access channel (xPRACH) of the MTC terminal 101 and information about a physical random access channel (PRACH) of the general terminal 103.

In this instance, each of the xPRACH of the MTC terminal 101 and the PRACH of the general terminal 103 may have separate resource spaces. That is, the general terminal 103 may use a resource space based on the information about the PRACH of the general terminal 103, and the MTC terminal 101 may use a resource space based on the information about the xPRACH of the MTC terminal 101.

In general, a separate xPRACH of the MTC terminal 101 is absent. Though a PRACH is increased for random access by the MTC terminal 101, the MTC terminal 101 may use a resource space of the PRACH simultaneously with the general terminal 103 and thus, the MTC terminal 101 and the general terminal 103 may affect each other.

Accordingly, the MTC terminal 101 and the general terminal 103 may contentiously use a common single resource space, and it may be difficult for the base station 105 to distinguish between a random access attempt from the MTC terminal 101 and a random access attempt from the general terminal 103 when receiving a random access attempt.

Thus, according to embodiments of the present invention, a separate resource space may be allocated to each of the xPRACH of the MTC terminal 101 and the PRACH of the general terminal 103, thereby preventing the MTC terminal 101 from affecting a random access of the general terminal 103. The base station 105 may distinguish a random access of the MTC terminal 101 from a random access of the general terminal 103, thereby simplifying a random access operation or a traffic transferring operation of an MTC terminal.

In operations 120 and 130, each of the MTC terminal 101 and the general terminal 103 receiving the SI that is broadcasted from the base station 105 may set a respective physical channel based on the information about the xPRACH of the MTC terminal 101 and the information about the PRACH of the general terminal 103 that are included in the SI.

In operations 140 and 150, the MTC terminal 101 and the general terminal 103 may attempt a random access to the base station 105 using the respective set physical channel

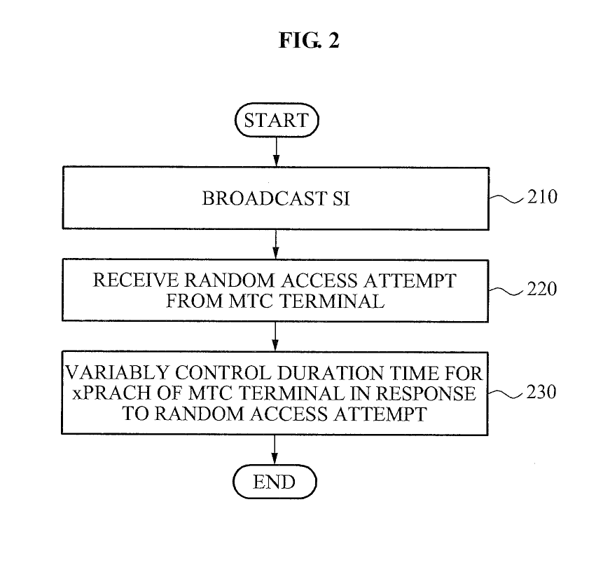

FIG. 2 is a flowchart illustrating a communication method of a base station for a random access resource allocation according to embodiments of the present invention.

Referring to FIG. 2, in operation 210, a base station for a random access resource allocation (hereinafter, referred to as a base station for convenience of description) may broadcast SI that includes information about an xPRACH of a MTC terminal and information about a PRACH of a general terminal

In this instance, each of the xPRACH of the MTC terminal and the PRACH of the general terminal may have a separated resource space.

The information about the xPRACH of the MTC terminal may include a period of duration for the xPRACH of the MTC terminal and an index that designates a subframe used by the xPRACH of the MTC terminal among subframes of a 3rd generation partnership project (3GPP) long term evolution (LTE) frame.

The base station may allocate, to the xPRACH of the MTC terminal, at least one subframe remaining after allocating subframes of a 3GPP LTE frame to the PRACH of the general terminal.

The index that designates a subframe used by the xPRACH of the MTC terminal described in the foregoing may correspond to an index for designating at least one subframe remaining after allocating subframes of a 3GPP LTE frame to the PRACH of the general terminal.

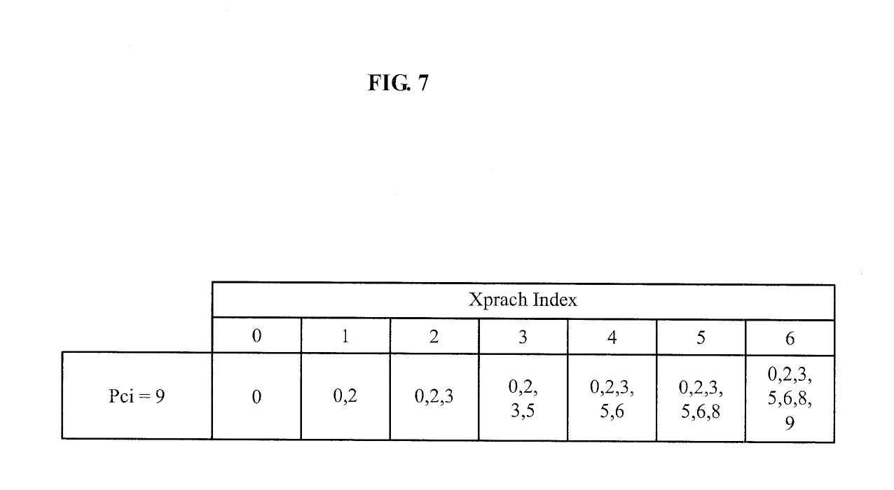

The base station may adjust an allocation of a subframe to the xPRACH of the MTC terminal using the index that designates the subframe. A scheme of adjusting an allocation of a subframe will be described with reference FIG. 7.

The base station may invalidate the xPRACH of the MTC terminal subsequent to the period of duration for the xPRACH of the MTC terminal.

In operation 220, the base station may receive a random access attempt from the MTC terminal in response to the broadcast.

In operation 230, the base station may variably control the period of duration for the xPRACH of the MTC terminal in response to the random access attempt from the MTC terminal.

For example, when the MTC terminal is to perform a predetermined operation at a starting time of 12 o'clock, the base station may maintain the period of duration for the xPRACH of the MTC terminal for ten minutes from the starting time of 12 o'clock. The base station may invalidate the xPRACH of the MTC terminal for a time period, subsequent to ten minutes after the starting time, corresponding to the period of duration for the xPRACH of the MTC terminal.

In this instance, when the MTC terminal takes longer than ten minutes to perform a predetermined operation, the base station may control the period of duration for the xPRACH of the MTC terminal to be a time period of, for example, fifteen minutes, twenty minutes, and the like.

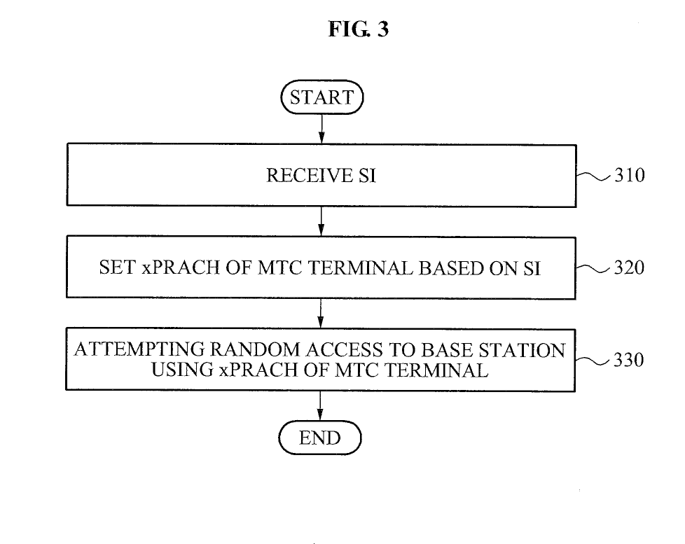

FIG. 3 is a flowchart illustrating a communication method of a terminal using a random access resource allocation according to embodiments of the present invention.

Referring to FIG. 3, in operation 310, a terminal using a random access resource allocation (hereinafter, referred to as a terminal for convenience of description) may receive, from a base station, SI that includes information about an xPRACH of a MTC terminal and information about a PRACH of a general terminal.

In this instance, each of the xPRACH of the MTC terminal and the PRACH of the general terminal may have separate resource spaces.

The information about the xPRACH of the MTC terminal may include a period of duration for the xPRACH of the MTC terminal and an index that designates a subframe used by the xPRACH of the MTC terminal among subframes of a 3GPP LTE frame.

The subframe used by the xPRACH of the MTC terminal may include at least one subframe remaining after allocating subframes of a 3GPP LTE frame to the PRACH of the general terminal.

Thus, the index that designates a subframe used by the xPRACH of the MTC terminal may correspond to an index for designating at least one subframe remaining after allocating subframes of a 3GPP LTE frame to the PRACH of the general terminal.

The xPRACH of the MTC terminal may be invalidated by the base station subsequent to the period of duration for the xPRACH of the MTC terminal.

In operation 320, the terminal may set the xPRACH of the MTC terminal based on the SI. Here, setting of the xPRACH of the MTC terminal may include verifying a number of a subframe, for example, 1, 2, 3 etc., among the subframes of the 3GPP LTE frame to be used by the terminal based on the SI to attempt a random access, and storing information about a subframe to be used by the terminal, for example, an index designating a subframe, and the like.

In operation 330, the terminal may attempt a random access to the base station using the xPRACH of the MTC terminal.

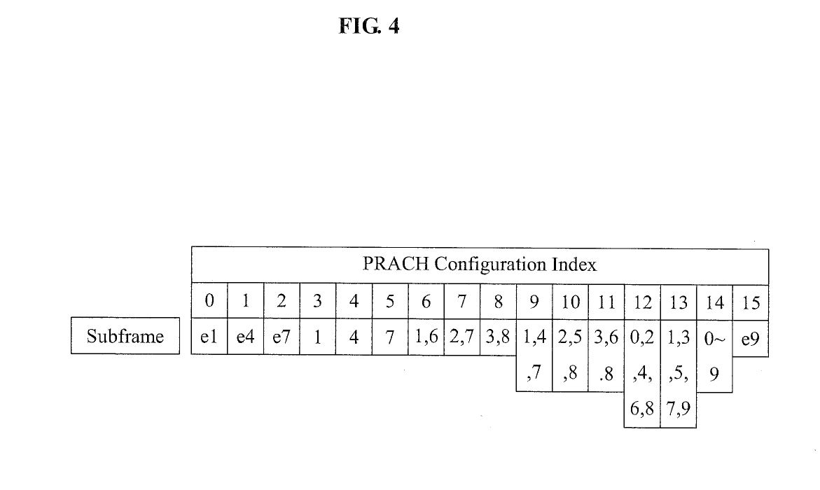

FIG. 4 is a diagram illustrating an allocation of a physical channel resource for a general terminal according to embodiments of the present invention.

A terminal of a 3GPP LTE system may perform a random access process basically to synchronize with a base station, by receiving information about an uplink timing from the base station, to set a power control for an initial uplink transmission, or to transmit a user message.

A PRACH may correspond to a physical channel used for transmitting a random access preamble in the random access process. The base station may allocate a PRACH resource to the terminal before transmitting the random access preamble, and the terminal may perform a random access using a PRACH that is uniquely designated.

A resource of the PRACH of the general terminal in the 3GPP LTE system may be allocated using SI as described in the foregoing. The SI corresponding to information about a physical channel of the general terminal may include a PRACH configuration index (PCI) for a resource allocation of the PRACH of the general terminal.

The PRACH PCI may be managed using a value in a range of 0 to 63, and may indicate a preamble format to be used by the general terminal in a cell and a subframe to be used in the preamble format.

The preamble format may be classified into format#0 when the PRACH PCI corresponds to a value in the range of 0 to 15, format#1 when the PRACH PCI corresponds to a value in the range of 16 to 31, format#2 when the PRACH PCI corresponds to a value in the range of 32 to 47, and format#3 when the PRACH PCI corresponds to a value in the range of 48 to 63. The subframe may have a predetermined combination for a value in the range of 0 to 9.

For example, referring to FIG. 4, when the PRACH PCI corresponds to a value of 9, the preamble format to be used by the general terminal may correspond to format#0, and the subframe to be used by the general terminal may correspond to {1, 4, 7}. Thus, the general terminal may perform a random access to the base station using the subframe corresponding to {1, 4, 7}. In this example, the base station may change the SI as necessary.

In response to a changed SI being broadcasted in the cell, the general terminal may receive a resource allocation according to information about a changed PRACH.

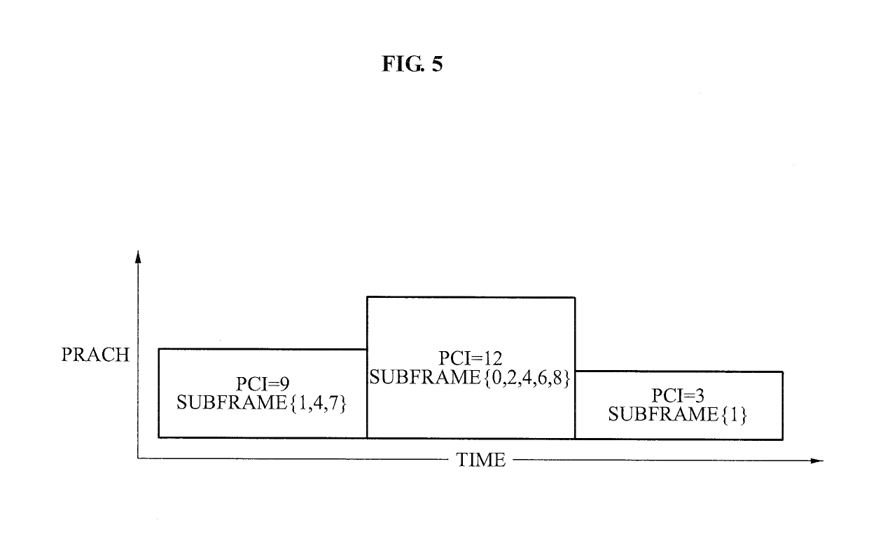

For example, a configuration of resources when the PRACH PCI changes from a value of 9 to a value of 12 and to a value of 3 due to the changed SI may be illustrated as FIG. 5.

FIG. 5 is a diagram illustrating a configuration of a physical channel resource of FIG. 4.

Referring to FIG. 5, in response to a PRACH PCI changing from a value of 9 to a value of 12 and to a value of 3, a subframe allocated to a general terminal may change from {1, 4, 7} to {0, 2, 4, 6, 8} and to {1}.

Thus, the general terminal may have an opportunity to transmit a random access preamble using a subframe appropriate to the corresponding configuration.

The opportunity to transmit a random access preamble may increase or decrease depending on a number of allocations of a PRACH. In this instance, the PRACH of the general terminal may provide equal opportunities for transmission to all terminals.

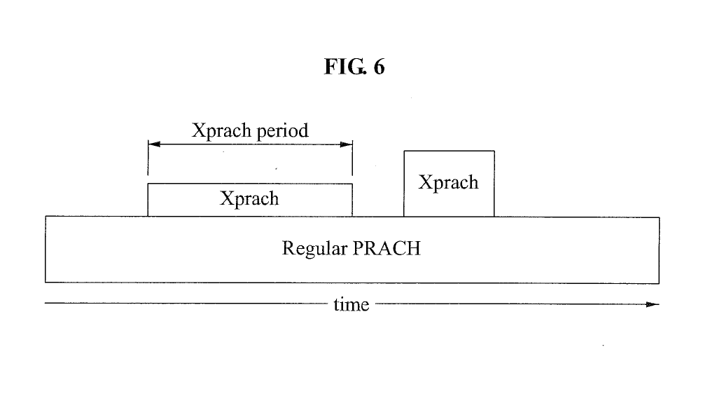

FIG. 6 is a diagram illustrating an allocation of a physical channel resource for an MTC terminal according to embodiments of the present invention.

Referring to FIG. 6, a resource may be allocated based on a characteristic of an MTC terminal described in the foregoing, and a period Xprach may correspond to a random access resource period allocated to the MTC terminal. A valid time interval corresponding to the period Xprach of a random access resource allocated to the MTC terminal may have a constant value, or may be variable. A portion Regular PRACH may correspond to a random access resource allocated to a general terminal.

A base station may broadcast information about an xPRACH of the MTC terminal, for example, information about allocating the xPRACH of the MTC terminal, and the like when the xPRACH of the MTC terminal is determined to be used.

The base station may cause the MTC terminal to attempt a random access using a random access resource allocated to the MTC terminal by broadcasting the information about the xPRACH of the MTC terminal.

The information about the xPRACH of the MTC terminal may include a period of duration for the xPRACH of the MTC terminal.

The xPRACH of the MTC terminal may be invalidated by the base station subsequent to the period of duration for the xPRACH of the MTC terminal. That is, the period of duration for the xPRACH of the MTC terminal may be unstable.

When the base station fails to specify the period of duration for the xPRACH of the MTC terminal, the xPRACH of the MTC terminal may be valid for an indefinite period of time. In this instance, the base station may perform a broadcast for removing the xPRACH of the MTC terminal to subsequently specify a removal of the xPRACH of the MTC terminal.

The base station may use the period of duration for the xPRACH of the MTC terminal by designating the period of duration to be {0 minutes, 10 minutes, 20 minutes, 40 minutes, . . . , M minutes, infinity}.

The base station may alleviate a load of a terminal due to a change of SI by controlling whether to perform a specific broadcast for the removal of the xPRACH of the MTC terminal.

As described in the foregoing, the base station may appropriately control a period for providing the xPRACH of the MTC terminal, as necessary, based on the period of duration for the xPRACH of the MTC terminal.

FIG. 7 is a diagram illustrating a subframe designated by an index that designates a subframe used by a PRACH of an MTC terminal according to embodiments of the present invention.

As described in the foregoing, information for allocating a regular PRACH may use a PRACH PCI, and a general terminal may select a subframe that may be used by the PRACH PCI and thus, an amount of the PRACH may be limited.

Thus, according to embodiments of the present invention, a subframe remaining after allocating subframes 0 to 9 of a 3GPP LTE frame to the regular PRACH may be used to allocate an xPRACH of the MTC terminal.

Hereinafter, a case in which the PRACH PCI corresponds to a subframe 9 will be described as an example.

Referring to FIG. 7, when the PRACH PCI corresponds to a subframe 9, subframes {1, 4, 7} may be allocated to the regular PRACH, and remaining subframes {0, 2, 3, 5, 6, 8, 9} may be used as an uplink resource other than use as a PRACH.

Thus, a portion of or all subframes {0, 2, 3, 5, 6, 8, 9} may be allocated to the xPRACH of the MTC terminal when a random access period of the MTC terminal arrives.

Information about the xPRACH of the MTC terminal may include an index (which may be referred to as an xPRACH index) that designates a subframe used by the xPRACH of the MTC terminal in addition to a period of duration for the xPRACH of the MTC terminal described in the foregoing.

According to embodiments of the present invention, the base station may increase a number of subframes used by the xPRACH of the MTC terminal from one to a maximum possible value, as necessary.

In this instance, the base station may control an allocation of a subframe to the xPRACH of the MTC terminal using the xPRACH index.

That is, the base station may control an allocation of a subframe to the xPRACH of the MTC terminal by variably setting an index that designates a portion of or all subframes {0, 2, 3, 5, 6, 8, 9} as necessary.

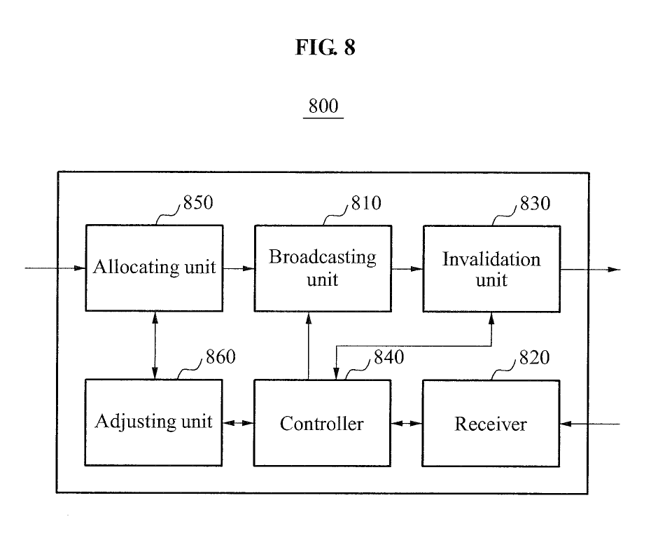

FIG. 8 is a block diagram illustrating a base station for a random access resource allocation according to embodiments of the present invention.

Referring to FIG. 8, a base station 800 for a random access resource allocation may include a broadcasting unit 810, a receiver 820, an invalidation unit 830, a controller 840, an allocating unit 850, and an adjusting unit 860.

The broadcasting unit 810 may broadcast SI that includes information about an xPRACH of an MTC terminal and information about a PRACH of a general terminal.

In this instance, each of the xPRACH of the MTC terminal and the PRACH of the general terminal may have a separated resource space.

The information about the xPRACH of the MTC terminal may include a period of duration for the xPRACH of the MTC terminal and an index that designates a subframe used by the xPRACH of the MTC terminal among subframes of a 3GPP LTE frame.

The receiver 820 may receive a random access attempt from the MTC terminal in response to the broadcast.

The invalidation unit 830 may invalidate the xPRACH of the MTC terminal subsequent to the period of duration for the xPRACH of the MTC terminal.

The controller 840 may variably control the period of duration for the xPRACH of the MTC terminal to allocate the xPRACH of the MTC terminal in response to the random access attempt from the MTC terminal.

The allocating unit 850 may allocate, to the xPRACH of the MTC terminal, at least one subframe remaining after allocating subframes of a 3GPP LTE frame to the PRACH of the general terminal.

The adjusting unit 860 may adjust an allocation of a subframe to the xPRACH of the MTC terminal using the index that designates the subframe.

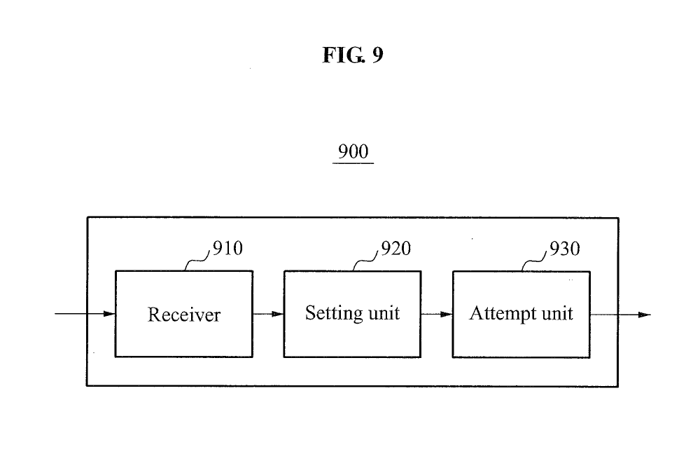

FIG. 9 is a block diagram illustrating a terminal using a random access resource allocation according to embodiments of the present invention.

Referring to FIG. 9, a terminal 900 using a random access resource allocation may include a receiver 910, a setting unit 920, and an attempt unit 930.

The receiver 910 may receive, from a base station, SI that includes information about an xPRACH of an MTC terminal and information about a PRACH of a general terminal.

In this instance, each of the xPRACH of the MTC terminal and the PRACH of the general terminal may have a separated resource space.

The information about the xPRACH of the MTC terminal may include a period of duration for the xPRACH of the MTC terminal and an index that designates a subframe used by the xPRACH of the MTC terminal among subframes of a 3GPP LTE frame.

The xPRACH of the MTC terminal may be invalidated by the base station subsequent to the period of duration for the xPRACH of the MTC terminal.

The subframe used by the xPRACH of the MTC terminal may correspond to at least one subframe remaining after allocating subframes of a 3GPP LTE frame to the PRACH of the general terminal.

The setting unit 920 may set the xPRACH of the MTC terminal based on the SI.

The attempt unit 930 may attempt a random access to the base station using the xPRACH of the MTC terminal.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### Description of Reference Number

101: MTC terminal
103: general terminal
105: base station

What is claimed is:

1. A communication method of a base station for random access resource allocation, the communication method comprising:
broadcasting system information (SI) that includes information about an extra physical random access channel (xPRACH) of a machine type communication (MTC) terminal and information about a physical random access channel (PRACH) of a general terminal, each of the xPRACH of the MTC terminal and the PRACH of the general terminal having a separated resource space; and
receiving a random access attempt from the MTC terminal in response to the broadcast.

2. The communication method of claim 1, wherein the information about the xPRACH of the MTC terminal includes a period of duration for the xPRACH of the MTC terminal and an index that designates a subframe used by the xPRACH of the MTC terminal among subframes of a 3rd generation partnership project (3GPP) long term evolution (LTE) frame.

3. The communication method of claim 2, further comprising:
invalidating the xPRACH of the MTC terminal subsequent to the period of duration for the xPRACH of the MTC terminal.

4. The communication method of claim 1, further comprising:
variably controlling the period of duration for the xPRACH of the MTC terminal to allocate the xPRACH of the MTC terminal in response to the random access attempt from the MTC terminal.

5. The communication method of claim 1, further comprising:
allocating, to the xPRACH of the MTC terminal, at least one subframe remaining after allocating subframes of a 3GPP LTE frame to the PRACH of the general terminal.

6. The communication method of claim 2, further comprising:
adjusting an allocation of a subframe to the xPRACH of the MTC terminal using the index that designates the subframe.

7. A communication method of a terminal using a random access resource allocation, the communication method comprising:
receiving, from a base station, system information (SI) that includes information about an extra physical random access channel (xPRACH) of a machine type communication (MTC) terminal and information about a physical random access channel (PRACH) of a general terminal, each of the xPRACH of the MTC terminal and the PRACH of the general terminal having a separate resource space;
setting the xPRACH of the MTC terminal based on the SI; and
attempting a random access to the base station using the xPRACH of the MTC terminal.

8. The communication method of claim 7, wherein the information about the xPRACH of the MTC terminal includes a period of duration for the xPRACH of the MTC terminal and an index that designates a subframe used by the xPRACH of the MTC terminal among subframes of a 3rd generation partnership project (3GPP) long term evolution (LTE) frame.

9. The communication method of claim 8, wherein the xPRACH of the MTC terminal is invalidated by the base station subsequent to the period of duration for the xPRACH of the MTC terminal.

10. The communication method of claim 8, wherein the subframe used by the xPRACH of the MTC terminal corresponds to at least one subframe remaining after allocating subframes of a 3GPP LTE frame to the PRACH of the general terminal.

11. A base station for a random access resource allocation, the base station comprising:
a broadcasting unit to broadcast system information (SI) that includes information about an extra physical random access channel (xPRACH) of a machine type communication (MTC) terminal and information about a physical random access channel (PRACH) of a general terminal, each of the xPRACH of the MTC terminal and the PRACH of the general terminal having a separated resource space; and
a receiver to receive a random access attempt from the MTC terminal in response to the broadcast.

12. The base station of claim 11, wherein the information about the xPRACH of the MTC terminal includes a period of duration for the xPRACH of the MTC terminal and an index that designates a subframe used by the xPRACH of the MTC terminal among subframes of a 3rd generation partnership project (3GPP) long term evolution (LTE) frame.

13. The base station of claim 12, further comprising:
an invalidation unit to invalidate the xPRACH of the MTC terminal subsequent to the period of duration for the xPRACH of the MTC terminal.

14. The base station of claim 11, further comprising:
a controller to variably control the period of duration for the xPRACH of the MTC terminal to allocate the xPRACH of the MTC terminal in response to the random access attempt from the MTC terminal.

15. The base station of claim 11, further comprising:
an allocating unit to allocate, to the xPRACH of the MTC terminal, at least one subframe remaining after allocating subframes of a 3GPP LTE frame to the PRACH of the general terminal.

16. The base station of claim 12, further comprising:
an adjusting unit to adjust an allocation of a subframe to the xPRACH of the MTC terminal using the index that designates the subframe.

17. A terminal using a random access resource allocation, the terminal comprising:
a receiver to receive, from a base station, system information (SI) that includes information about an extra physical random access channel (xPRACH) of a machine type communication (MTC) terminal and information about a physical random access channel (PRACH) of a general terminal, each of the xPRACH of the MTC terminal and the PRACH of the general terminal having a separated resource space;
a setting unit to set the xPRACH of the MTC terminal based on the SI; and
an attempt unit to attempt a random access to the base station using the xPRACH of the MTC terminal.

18. The terminal of claim 17, wherein the information about the xPRACH of the MTC terminal includes a period of duration for the xPRACH of the MTC terminal and an index that designates a subframe used by the xPRACH of the MTC terminal among subframes of a 3rd generation partnership project (3GPP) long term evolution (LTE) frame.

19. The terminal of claim 18, wherein the xPRACH of the MTC terminal is invalidated by the base station subsequent to the period of duration for the xPRACH of the MTC terminal.

20. The terminal of claim 18, wherein the subframe used by the xPRACH of the MTC terminal corresponds to at least one subframe remaining after allocating subframes of a 3GPP LTE frame to the PRACH of the general terminal.
